(19) United States
(12) Patent Application Publication
(10) Pub. No.: US 2026/0368633 A1
(43) Pub. Date: Nov. 19, 2026

(54) METHODS AND APPARATUSES FOR ENABLING SELECTION OF A MACHINE LEARNING MODEL FOR USE IN PROVIDING A SERVICE

(71) Applicant: Telefonaktiebolaget LM Ericsson (publ), Stockholm (SE)

(72) Inventors: Swarup Kumar MOHALIK, Bangalore (IN); Danesh DAROUI, Göteborg (SE); Miguel Angel GARCIA MARTIN, Madrid (ES)

(73) Assignee: Telefonaktiebolaget LM Ericsson (publ), Stockholm (SE)

(21) Appl. No.: 19/487,526

(22) PCT Filed: May 31, 2023
(86) PCT No.: PCT/SE2023/050535

§ 371 Date: Nov. 25, 2025

(51) Int. Cl. G06N 20/00

(52) U.S. Cl. CPC G06N 20/00

(57) ABSTRACT

Embodiments described herein relate to methods and apparatuses for enabling selection of a selected machine learning, ML, model for use in providing a service. A method in a model selection function comprises obtaining an indication of a plurality of ML models and a set of parameters with associated values representative of a context for the service; determining, based on the set of parameters with associated values, at least one applicable selection rule, wherein each applicable selection rule is associated with a logical expression which, when evaluated over one or more of the set of parameters, is true, and wherein each applicable selection rule comprises selection weighting values, wᵢ, indicating weightings to be applied to respective features, featureᵢ, in determining respective ranks of the plurality of ML Models, wherein each respective feature comprises a input feature for at least one of the plurality of ML models; for each first ML model in the plurality of ML models: obtaining global weighting values, uᵢ, indicating relative impacts of the respective features when the first ML model outputs predictions; and determining a model rank of the first ML model from the global weighting values and the selection weighting values; and initiating use of the selected ML model from one or more candidate ML models based on the respective model ranks of the one or more candidate ML models.

### TECHNICAL FIELD

Embodiments described herein relate to methods and apparatuses for enabling selection of a selected machine learning, ML, Model for use in providing a service.

### BACKGROUND

A Network Data Analytics Function (NWDAF) is a network function within a 5G core network (CN) that is designed to provide analytics reports to a service consumer. The service consumer identifies the type of requested analytics with an Analytics ID. An analytics report may comprise either statistics from the past or prediction for the future.

Two main logical functions inside NWDAF are responsible for generating an analytics report:
1. A Model Training Logical Function (MTLF, hereby referred to as ‘MTLF’), responsible for training, generating, and provisioning ML models an analytics logical function, AnLF.
2. An Analytics Logical Function (AnLF), responsible for inference, generating analytics reports using the relevant ML model, and exposing analytics services to analytics consumers.

An NWDAF may comprise one or both of the AnLF and the MTLF.

FIG. 1 illustrates an internal architecture of an NWDAF with the logical functions inside i.e., MTLF and AnLF. Nnwdaf services are used for ML model provisioning and for receiving requests from a service consumer and sending its requested analytics report.

In some scenarios, there are multiple ML models, possibly generated by MTLF from different vendors, that can be trained and deployed in MTLF to provide analytics reports for a given analytics ID. In these scenarios, it is a reasonable assumption that each of the MTLFs generate different ML models, each one created with a different data set, thus, targeting different context or scenarios.

### Use Case Context

3GPP studied in TR 23.700-81 version 18.0.0 several key issues and invited solution proposals. Key issue #1, is “How to improve correctness of NWDAF analytics”. Solution proposal #62, expressed in TR 23.700-81 version 18.0.0, introduces Use Case Context (UCC) as an optional parameter to address KI #1.

An example of UCC parameters and possible values is shown in Table 1 below.

TABLE 1
Example of UCC parameters.

| UCC Parameter | Value |
|---|---|
| Place | home, office |
| timeOfDay | morning, evening, night |
| Activity | atWork, driving |
| Situation | lean, peak |

### Multiple ML Models

Solution #1, proposed in TS 23.700-81 version 18.0.0 also addresses KI #1, which is “How to improve correctness of NWDAF analytics”. This solution proposal suggests multiple ML models maintained by MTLF and focuses on associating analytics IDs to ML models and the protocol aspects to access the ML models for inference in AnLF. However, the actual selection of the final report is left open, as shown in the text below:
. . . Having the NWDAF containing AnLF multiple ML models to choose from, enables use cases where an ML model can be selected depending on, e.g., the UE location, time of day, network load, or any other filter of information.
. . . Upon reception of multiple ML model information for the same Analytics ID, the NWDAF containing AnLF should be able to choose and download the model(s) of its choice.
. . . Once a given ML model has generated a prediction, an internal logic in the aggregation/voting unit selects the best prediction and delivers it to the consumer.

### SUMMARY

Overall architecture and signaling between an instance of NWDAF that supports multiple ML models, and a service consumer, is already standardized and expressed in a few proposals in 3GPP TS 23.288 version 18.1.0. However, there is no solution in the standards that would describe how an AnLF is able to choose an ML model to generate the most accurate analytics report, for example, in case of a prediction.

If the AnLF selects a less-optimized or less-accurate ML model for the scenario demanded by the analytics consumer, this may lead to the consumer receiving less accurate/relevant report from AnLF, which can negatively impact the performance of other NF's, network, and services.

The problem to be solved is how can the AnLF select the best possible ML model which can provide the best analytics report taking into account the context of the service consumer.

According to some embodiments there is provided a method, performed by a model selection function for enabling selection of a selected machine learning, ML, model for use in providing a service. The method comprises obtaining an indication of a plurality of ML models and a set of parameters with associated values representative of a context for the service; determining, based on the set of parameters with associated values, at least one applicable selection rule, wherein each applicable selection rule is associated with a logical expression which, when evaluated over one or more of the set of parameters, is true, and wherein each applicable selection rule comprises selection weighting values, wᵢ, indicating weightings to be applied to respective features, featureᵢ, in determining respective ranks of the plurality of ML Models, wherein each respective feature comprises a input feature for at least one of the plurality of ML models; for each first ML model in the plurality of ML models: obtaining global weighting values, uᵢ, indicating relative impacts of the respective features when the first ML model outputs predictions; and determining a model rank of the first ML model from the global weighting values and the selection weighting values; and initiating use of the selected ML model from one or more candidate ML models based on the respective model ranks of the one or more candidate ML models.

According to some embodiments there is provided a model selection function for enabling selection of a selected machine learning, ML, Model for use in providing a service, the model selection function comprising processing circuitry configured to cause the model selection function to perform the method described above.

According to some embodiments there is provided a method, performed by a model explanation function, for enabling selection of a selected machine learning, ML, model for use in providing a service. The method comprises receiving a first request, from a first function, for global weighting values for a first ML model, wherein the global weighting values indicate relative impacts of respective features when the first ML model outputs predictions; obtaining the global weighting values for the first ML model; and transmitting the global weighting values to the first function.

According to some embodiments there is provided a model explanation function for enabling selection of a selected machine learning, ML, Model for use in providing a service. The model explanation function comprising processing circuitry configured to cause the model explanation function to perform the method described above.

According to some embodiments there is provided a method, performed by an analytics function, for selecting a selected machine learning, ML, model for use in providing a service at the analytics function. The method comprises transmitting a request, to a model selection function, wherein the request comprises an indication of a plurality of ML models and a set of parameters with associated values representative of a context for the service; and receiving a first response from the model selection function comprising an indication of one or more candidate ML models, wherein the first response is indicative of respective model ranks of the one or more candidate ML models.

According to some embodiments there is provided an analytics function for enabling selection of a selected machine learning, ML, Model for use in providing a service. The analytics function comprises processing circuitry configured to cause the analytics function to perform the method described above.

Aspects and examples of the present disclosure thus provide methods and apparatuses that enable an analytics function (e.g. an AnLF) to provide an analytics report in response to a service request that is most suitable to the UCC of the service consumer.

For the purposes of the present disclosure, the term “ML model” encompasses within its scope the following concepts:
Machine Learning processes, comprising processes or instructions through which data may be used in a training process to generate a model artefact for performing a given task, or for representing a real world process or system;
the model artefact that is created by such a training process, and which comprises the computational architecture that performs the task; and
the process performed by the model artefact in order to complete the task.

References to “ML model”, “model”, model parameters”, “model information”, etc., may thus be understood as relating to any one or more of the above concepts encompassed within the scope of “ML model”.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 illustrates an internal architecture of an NWDAF with the logical functions inside;

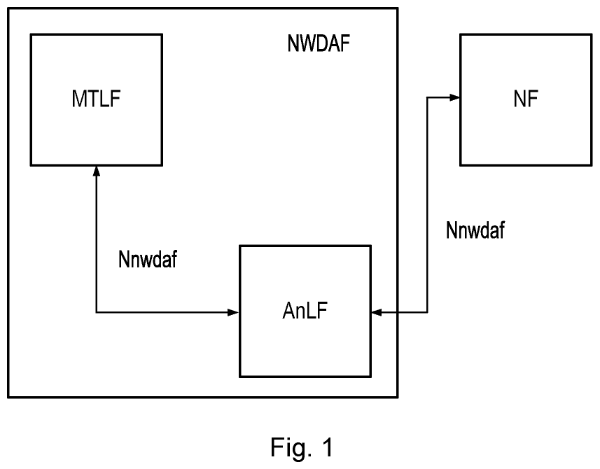

FIG. 2 illustrates an example system 200 for implementation of some embodiments;

FIG. 3 illustrates a method performed by a model selection function;

FIG. 4 is a graphical illustration of an example global explainability;

FIG. 5 illustrates a method performed by a model selection function;

FIG. 6 is a graphical illustration of an example of local explainability;

FIG. 7 illustrates a method, performed by a model explanation function;

FIG. 8 illustrates an example implementation of steps 701 to 703 of FIG. 7;

FIG. 9 illustrates an example implementation of steps 704 to 706 of FIG. 7;

FIG. 10 illustrates a method performed by an analytics function;

FIG. 11 illustrates an example implementation of steps 302 to 304 of FIG. 3;

FIG. 12 is a signalling diagram of an example implementation of FIGS. 3, 5, 7 and 10;

FIG. 13 illustrates a network function 1300 (e.g. a MSeF, and MLxF or an AnLF) comprising processing circuitry (or logic);

FIG. 14 is a block diagram illustrating an model selection function according to some embodiments;

FIG. 15 is a block diagram illustrating a model explanation function according to some embodiments;

FIG. 16 is a block diagram illustrating an analytics function according to some embodiments.

### DESCRIPTION

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s), and (where appropriate) state machines capable of performing such functions.

Certain aspects of the present disclosure and their embodiments may provide solutions to these or other challenges. The steps of any methods disclosed herein do not have to be performed in the exact order disclosed, unless a step is explicitly described as following or preceding another step and/or where it is implicit that a step must follow or precede another step.

Particular embodiments are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

Embodiments described herein formalize some existing proposals for user case context.

Furthermore, one or more new logical functions and artifacts for the NWDAF are defined for the explainability of ML Models, selecting models/analytics reports based on context of usage of the analytics reports and explainability information, and/or protocols for obtaining analytics reports for analytics ID's served by multiple ML models.

In embodiments described herein the Use Case Context (UCC) information may be used for explainability purposes to determine the best available analytics report from amongst those available from a plurality of ML models.

Various interfaces may be utilised to provide explainability information and custom implementation of the selection logic based on UCC and explainability. A standardized, open interface may provide improved reporting that is more informed and more relevant in a multi-vendor scenario.

In particular, embodiments described herein provide new NWDAF functionalities-formalization of context and contextual rules configuration store, and/or a new protocol for obtaining analytics reports when there is a plurality of ML models available for the same analytics ID.

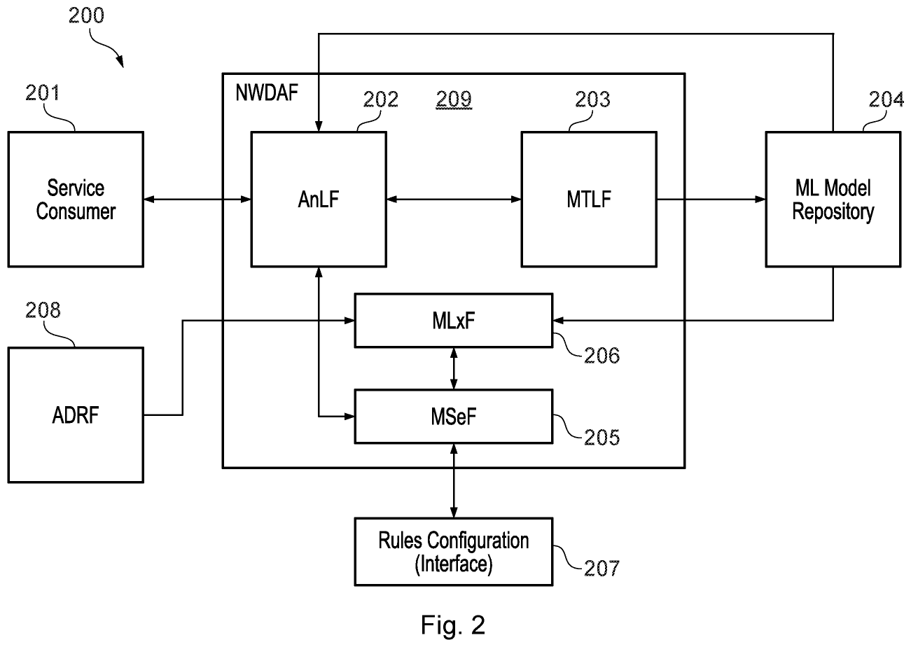

FIG. 2 illustrates an example system 200 for implementation of some embodiments.

The system 200 comprises a service consumer 201 which is configured to transmit service requests to an analytics function (AnLF) 202. The AnLF may be configured to utilise a ML model to provide the service. The ML model may be retrieved from the MTLF 203.

An ML model repository 204 may be utilised to store previously generated ML models. The ML models may be stored alongside appropriate Analytics IDs that identify the type of analytics report they produce. The MTLF 203 may retrieve previously generated ML models form the ML model repository for passing to the AnLF 202 when requested. The ML model repository 204 may be integrated with the ADRF 208 (described later).

In the system 200 two further network functions are introduced:
A Model Selection Function (MSeF) 205
A Model Explanation Function (MLxF) 206.

The MSeF and the MLxF are introduced to perform an explainability process which aims to choose the best ML models that meet certain rules, and finally select the most suitable generated analytics report.

In some examples, any two or more of the MseF, MLxF, AnLF and MTLF may be collocated within a Network Data Analytics Function, NWDAF 209. However, it will be appreciated that the functions MseF, MLxF, AnLF and MTLF may be hosted in separate network nodes or utilising distributed computing.

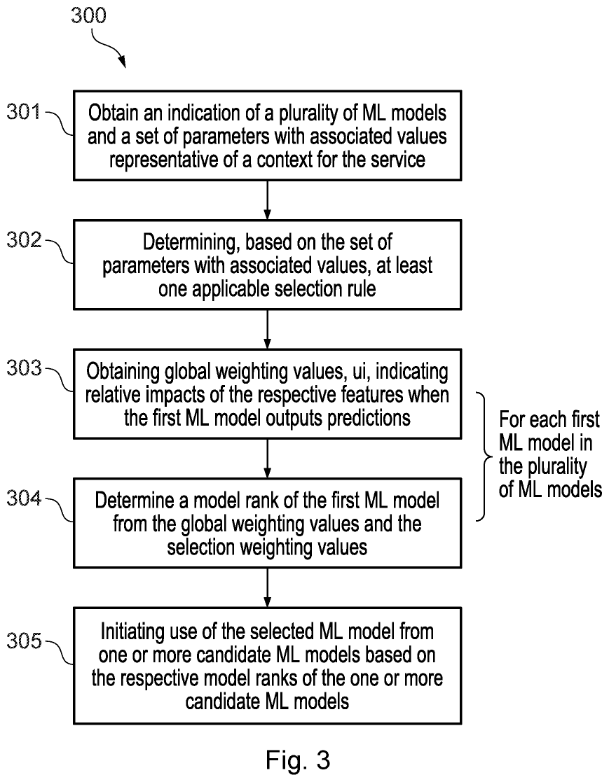

The MSeF 205 is configured to receive and implement selection rules over a rules configuration interface 207. This process will be described in more detail with reference to FIG. 3. A system developer may utilise the rules configuration interface 207 to submit rules to the MSeF.

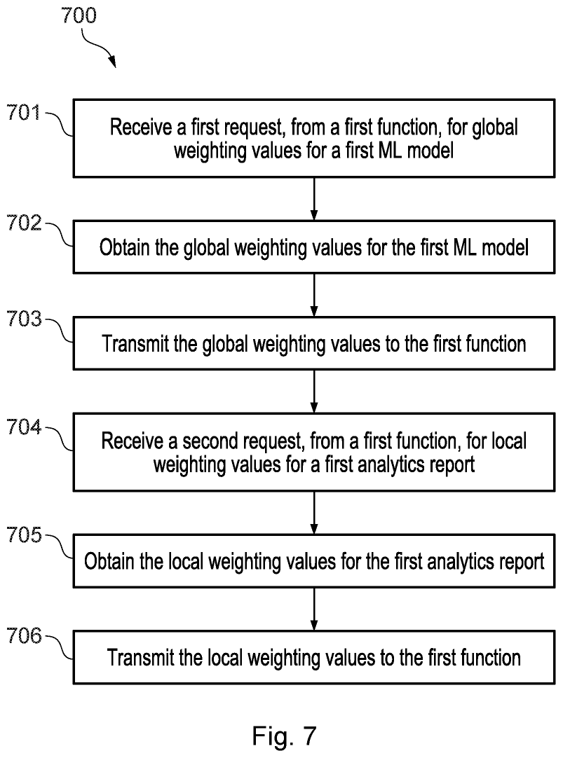

The MLxF performs global and/or local explainability operations as will be described in more detail with reference to FIG. 7. An Analytics Data Repository Function (ADRF) may provide training data to the MLxF for use in generating global or local explainers.

In embodiments described herein, no information about the ML models which have been used to generate analytics reports are exposed to the service consumer 201. In the procedures described herein, the UCC and analytics ID are the only information that is transferred from the analytics service Consumer 201 to the AnLF 202. Consequently, for the procedures described herein, the UCC and analytics ID may be the only common data that is known by both service consumer 201 and AnLF 202. It will be appreciated that in the execution of other procedures, the AnLF and the service consumer 201 may exchange other information such as: a target for the analytics, an analytics filter, time windows, etc.

Herein, the functionality of the MSeF, MLxF and AnLF are described separately. However, it will be appreciated that in some examples, the functionality of one or more of the MSeF 205, the MLxF 206 and the AnLF 202 may be performed by a single logical function (e.g. an NWDAF). In such examples there would be not logical interface between these functions as illustrated in FIG. 2.

The implementation of the functions may be left to the vendors. In some embodiments, MSeF and MLxF can be completely encapsulated within an NWDAF (MTLF) instance with fixed implementations of the explanation and selection function.

However, in some embodiments, the MSeF and MLxF have exposed interfaces to enable the following capabilities:
1. Providing explainers for new third-party models for the same analytics ID.
2. Updating the explainers based on changed data distribution.
3. Updating the selection methods based on new UCC attributes.

These dynamic functionalities may not be possible if MLxF 206 and MSeF 205 are collocated with NWDAF (MTLF).

FIG. 3 illustrates a method performed by a model selection function, MSeF 205, for enabling selection of a selected machine learning, ML, Model for use in providing a service.

The method 300 may be performed by a network node, which may comprise a physical or virtual node, and may be implemented in a computing device or server apparatus and/or in a virtualized environment, for example in a cloud, edge cloud or fog deployment.

In step 301 the MSeF 205 obtains an indication of a plurality of ML models and a set of parameters with associated values representative of a context for the service. The set of parameters may comprise a UCC.

Step 301 may comprise receiving the indication of the plurality of ML Models and the set of parameters with associated values representative of the context for the service from a consumer, e.g. an AnLF 202.

Step 301 may further comprise obtaining an indication of an analytics ID indicative of a type of analytics report required.

In step 302, the MSeF 205 determines, based on the set of parameters with associated values, at least one applicable selection rule, wherein each applicable selection rule is associated with a logical expression which, when evaluated over one or more of the set of parameters, is true.

Each applicable selection rule comprises selection weighting values, wᵢ, indicating weightings to be applied to respective features, featureᵢ, in determining respective ranks of the plurality of ML Models, wherein each respective feature comprises an input feature for at least one of the plurality of ML models.

The MSeF 205 may be configured with one or more selection rules, for example by a developer via the selection rules configuration interface 207 illustrated in FIG. 2. The one or more selection rules may be associated with an Analytics ID indicating the type of analytics report is it applicable to.

The selection rules configuration interface 207 may therefore provide the following service operations:
Set_Rules (analytics_id, rules)
Response to developer with indication of a Success/Failure of configuration of the rules

The selection rules may be generalised as:
[analytics ID][logical expression]→[feature₁: w₁, . . . featureᵢ: wᵢ . . . featureₙ: wₙ]

In the above generalised expression, the logical expression is evaluated over parameters in the set of parameters (e.g., the UCC). The logical expression may evaluate to true or false.

As stated above, a selection rule may be considered applicable when the logical expression evaluates to true. A selection rule may also only be considered applicable when the analytics ID of the selection rule matches the analytics ID obtained in step 301.

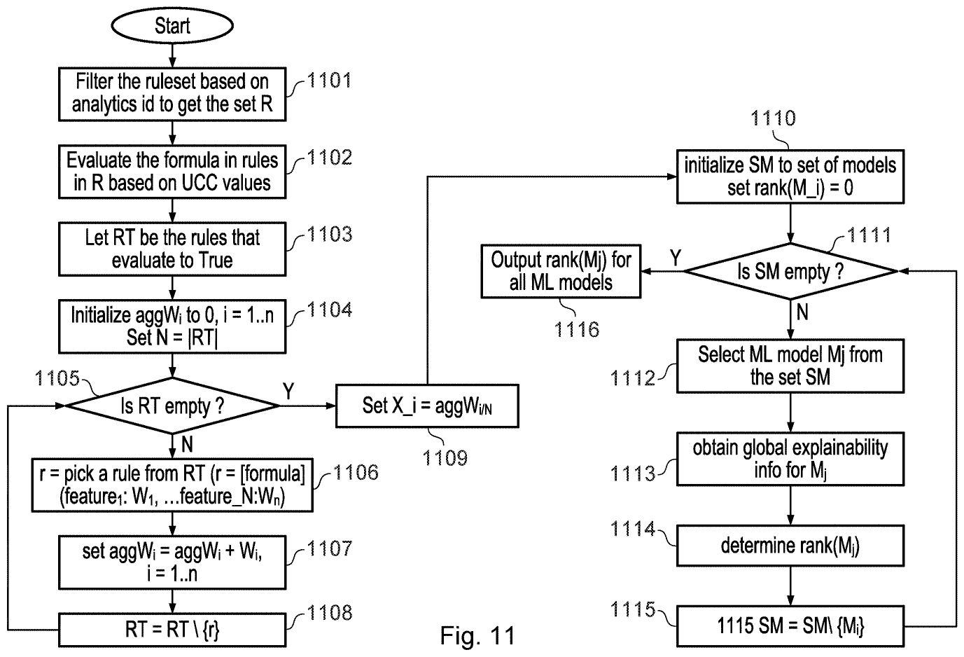

In examples in which multiple selection rules may be applicable, there may be some internal logic utilised to select a single set of selection weighting values. For example, the selection weighting values from the multiple selection rules for may be averaged for each feature as will be described in more detail with reference to FIG. 11.

The following provides two illustrative examples of a selection rule:
Selection Rule 1: [ID1] Situation==peak→[#ue: 0.6, location: 0.4]
Selection Rule 2: [ID4] Activity==driving→[location: 0.8, SINR: 0.2]

In Selection Rule 1, during peak hours ML models giving a higher importance to the number of UEs (#ue) over the locations of the UE are preferred.

In Selection Rule 2, when a service consumer is driving, the ML models giving a location a higher importance over the Signal to interference plus noise ratio (SINR) are preferred.

Steps 303 and 304 may be performed by the MSeF 205 for each first ML model in the plurality of ML models.

In step 303 the MSeF 205 obtains global weighting values, uᵢ, indicating relative impacts of the respective features when the first ML model outputs predictions. In some examples, these global weighting values may be retrieved from the MLxF 206 as described with reference to FIG. 7. In other words, the method of FIG. 3 may further comprise transmitting a request for the global weighting values to the MLxF 206, wherein the request comprises an indication of the first ML model; and responsive to transmitting the request, receiving the global weighting values from the model explainer function.

How the global weighting values, uᵢ may be determined will be described in more detail with reference to FIG. 7.

The global weighting values provide a ranking of the features importance in the first ML model, which indicates the relative impact of the features on the first ML model's output predictions.

The global explainability of a first ML model may comprise the global weighting values for all input features of the first ML model. The global explainability of a first ML model may be presented in the following form, where a global weighting value is associated to each feature based on the importance:
Global Explainability of ML Model_1→[feature₁: u₁, . . . , featureₙ: uₙ]

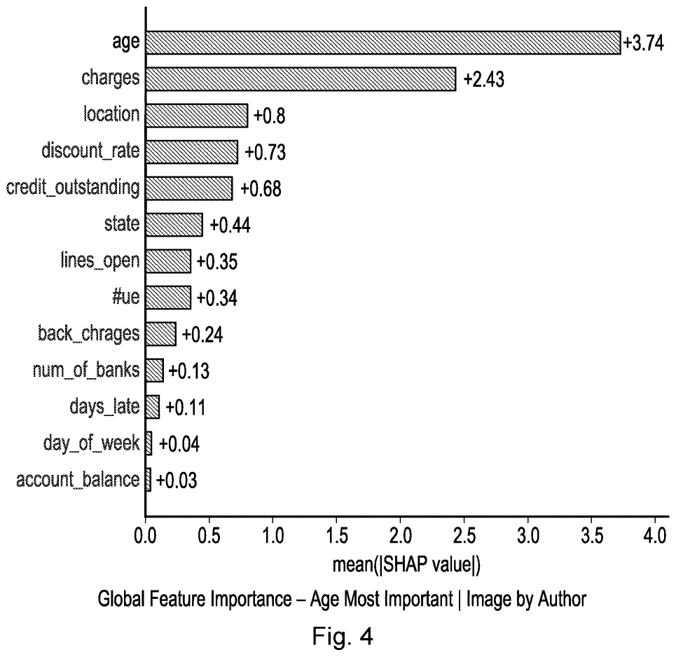

A graphical illustration of an example global explainability of a ML model is illustrated in FIG. 4. In this example, the features are indicated on the y-axis and the associated global weighting values for each feature is indicated on the x-axis.

In step 304 the MSeF 205 determines a model rank of the first ML model from the global weighting values and the selection weighting values.

In some examples, step 304 comprises for each feature, featureᵢ, multiplying the respective global weighting value, u; and the respective selection weighting valued, wᵢ to determine a model feature weighting, uᵢwᵢ, and summing the model feature weightings for all input features of the first ML model.

In other words, the model rank for a first ML model may be calculated as:

$${\sum }_{i = 1}^{n} {u}_{i} {w}_{i} .$$

It will be appreciated that if a feature is not mentioned in any of the at least one applicable selection rule, then that feature may be effectively nullified in the calculation of the model rank.

So for the example illustrated in FIG. 4, if it is assumed that only Selection Rule 1 applies, the model rank would be 0.34*0.6+0.8*0.4=0.524

In step 305 the MSeF 205 initiates use of the selected ML model from one or more candidate ML models based on the respective model ranks of the one or more candidate ML models.

The initiation of step 305 may be made in a number of different ways. Where the MSeF 205 and the consumer (e.g., AnLF 202) form separate logical functions, step 305 may comprise transmitting a first response to the consumer (e.g., AnLF 202) comprising an indication of the one or more candidate ML models, wherein the first response is indicative of the respective model ranks of the one or more candidate ML models.

In some examples, the first response may indicate only the one or more candidate ML models that have respective model ranks that meet a criterion. For example, the first response may indicate Y candidate ML models, where Y is an integer number, associated with the Y highest respective model ranks.

In other examples, the first response may indicate one or more candidate ML models that are associated with respective model ranks that are greater than a predetermined threshold.

In some examples, the first response comprises an indication of the respective model ranks for the one or more candidate ML models. In this case, the first response may indicate the model ranks for all of the plurality of ML models obtained in step 301. In other words, all of the plurality of ML models are seen by the MSeF 205 as candidate ML models, and the AnLF 202 may implement the further logic (e.g., top Y models, or model ranks greater than a predetermined threshold) in order to determine candidate ML models.

If the MSeF 205 receives no further response to the first response, it may be assumed that the AnLF 202 has selected a selected ML model from the one or more candidate ML models. For example, either there was only one candidate ML model or a selected ML model was selected by the AnLF 202 using some internal logic (e.g. first listed ML Model).

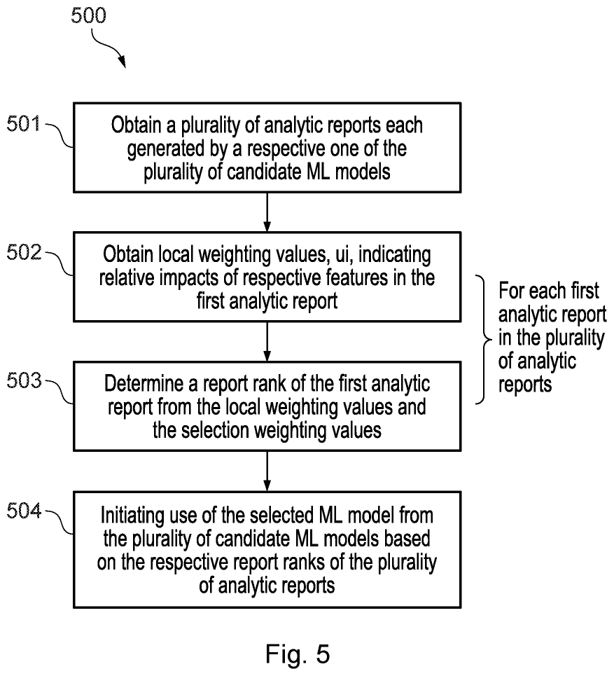

If the AnLF 202 does not select a selected ML model from the first response, the MSeF 205 may receive an indication of a plurality of analytic reports as will be described in more detail with reference to FIG. 5.

However, where a single logical function is utilised to implement the functionality of at least the MSeF 205 and the AnLF 202, the single logical function may perform step 305 by responsive to there being only one candidate ML model selecting the candidate ML model as the selected ML model to perform the service. Responsive to there being a plurality of candidate ML models, the single logical function may select one of the candidate ML models to perform the service using some internal logic (e.g. first listed).

In other examples, generating a plurality of analytics reports each generated by a respective one of the plurality of candidate models. This plurality of analytics reports may then be further filtered by the functionality of the MSeF 205 as will be described below with reference to FIG. 5.

FIG. 5 illustrates a method performed by a model selection function, for enabling selection of a selected machine learning, ML, Model for use in providing a service. It will be appreciated that the method of FIG. 5 may be performed after step 305 of FIG. 3 in circumstances where the selected ML model is not selected at that stage.

In step 501 MSeF 205 obtains a plurality of analytic reports each generated by a respective one of the plurality of candidate ML models. As previously described the MSeF 205 may receive the plurality of analytic reports from the MLxF 206.

Steps 502 and 503 may be performed for each first ML model in the plurality of ML models.

In step 502 the method comprises obtaining local weighting values, uᵢ, indicating relative impacts of respective features in the first analytic report. How the global weighting values, uᵢ may be determined will be described in more detail with reference to FIG. 7. In local explainability, a given prediction is explained through the relative impacts of the features used for the prediction. Local explainability information may be presented in the following form, where each feature, featureᵢ, in the ML model is associated to a local weighting, vᵢ, with respect to the generated analytics reports:
Local Explainability of ML Model_1, report_1→[feature₁: v₁, . . . , featureₙ: vₙ]

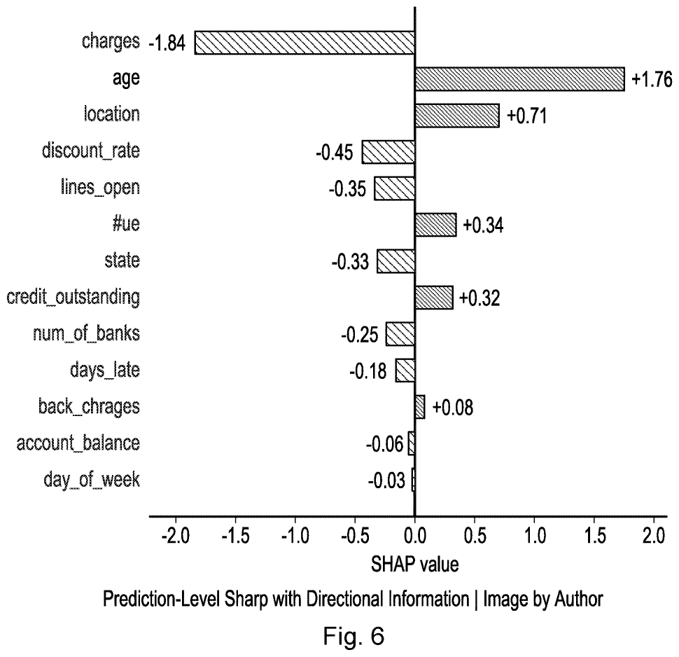

A graphical illustration of an example of local explainability of a report produced by an ML model is illustrated in FIG. 6. In this example, the features are indicated on the y-axis and the associated local weighting values for each feature are indicated on the x-axis.

In step 503 the MSeF 205 determines a report rank of the first analytic report from the local weighting values and the selection weighting values.

In some examples, step 503 comprises for each feature, featureᵢ, multiplying the respective local weighting value, vᵢ and the respective selection weighting value, wᵢ to determine a report feature weighting, vᵢwᵢ, and summing the report feature weightings for all input features of the first ML model that generated the first analytic report.

In other words, the report rank for a first analytic report may be calculated as:

$${\sum }_{i = 1}^{n} {v}_{i} {w}_{i} .$$

It will be appreciated that if a feature is not mentioned in any of the at least one applicable selection rules, then that feature may be effectively nullified in the calculation of the model rank.

So for the example illustrated in FIG. 6, if it is assumed that only Selection Rule 1 applies, the report rank would be 0.34*0.6+0.71*0.4=0.488

In step 504 the MSeF 205 initiates use of the selected ML model from the plurality of candidate ML models based on the respective report ranks of the plurality of analytic reports.

The initiation of step 504 may be made in a number of different ways. Where the MSeF 205 and the consumer (e.g. AnLF 202) form separate logical functions, step 504 may comprise transmitting a second response to the consumer (e,g, AnLF 202) comprising an indication of one or more candidate analytic reports, wherein the second response is indicative of the respective report ranks of the one or more candidate analytic reports.

In some examples, the second response may indicate only the one or more candidate analytic reports that have respective report ranks that meet a criterion. For example, the second response may indicate X analytic reports, where X is an integer number, associated with the X highest respective report ranks.

In other examples, the second response may indicate one or more candidate analytic reports that are associated with respective report ranks that are greater than a predetermined threshold.

In some examples, the second response comprises an indication of the respective report ranks for the one or more candidate analytic reports. In this case, the second response may indicate the report ranks for all of the plurality analytic reports obtained in step 501. The consumer (e.g. AnLF 202) may then implement the further logic in order to select a selected ML model based on the report ranks.

However, where a single logical function is utilised to implement the functionality of at least the MSeF 205 and the AnLF 202, the single logical function may perform step 504 by selecting an analytic report based on the analytic report ranks. For example, the selected analytic report may be the analytic report with the highest analytic report rank. The single logical function may then utilise the selected analytic report to perform the service.

It will be appreciated that the MSeF 205 may therefore accept requests from e.g. AnLF 202 to trigger global/local explainability process. The interface towards MSeF 205 may in some examples be considered to comprise the following service operations:
Set_Rules (analytics_id, rules)
   Response with [Success/Failure]
Select_Model (analytics_id, UCC, global==true):
   Response returns a ranked set of model_ids.
Select_Result (analytics_id, model_ids, UCC, analytics_reports, local==true)

FIG. 7 illustrates a method, performed by a model explanation function, for enabling selection of a selected machine learning, ML, model for use in providing a service. In this embodiment, the MLxF 206 is depicted as forming a separate logical function to the MSeF 205. It will however be appreciated that in some examples these two functions (MSeF 205 and MLxF 206 form a single logical function).

In step 701 the MLxF 206 receives a first request, from a first function, for global weighting values for a first ML model, wherein the global weighting values indicate relative impacts of respective features when the first ML model outputs predictions. The first function may comprise the MSeF 205 as described above with reference to FIGS. 2 to 5, or any other suitable consumer.

In step 702, the method comprises obtaining the global weighting values for the first ML model.

Step 702 may comprise utilising a global explainer to obtain the global weighting values. A suitable global explainer for the first ML model may have previously been generated by the MLxF 206, or may need to be generated upon receipt of the first request in step 701.

In step 703 the MLxF 206 transmits the global weighting values to the first function (e.g. the MSeF 205.

The method of FIG. 7 may in some examples further comprise steps 704 to 706.

In step 704 the MLxF 206 receives a second request, from the first function, for local weighting values for a first analytics report, wherein the local weighting values indicate relative impacts of respective features in the first analytics report.

In step 705 the MLxF 206 obtains the local weighting values for the first analytics report. Step 705 may comprise utilising a local explainer to obtain the local weighting values. A suitable local explainer for the first ML model may have previously been generated by the MLxF 206, or may need to be generated upon receipt of the first request in step 704.

In step 706 the MLxF 206 transmits the local weighting values to the first function.

It will therefore be appreciated, that the MLxF 206 may be considered to provide an interface to accept requests for generating global/local explainers and notifying the consumer (e.g. MSeF 205) when the explainer is ready. The proposed interface may comprise following services:
Get_Local_Explainability_Info(model_ids, analytics_reports, analytics_id)
Get_Global_Explainability_Info(model_ids, analytics_id)
Local_Explainability_Info(model_ids, analytics_reports, analytics_id)
Global_Explainability_Info(model_ids, analytics_reports, analytics_id)

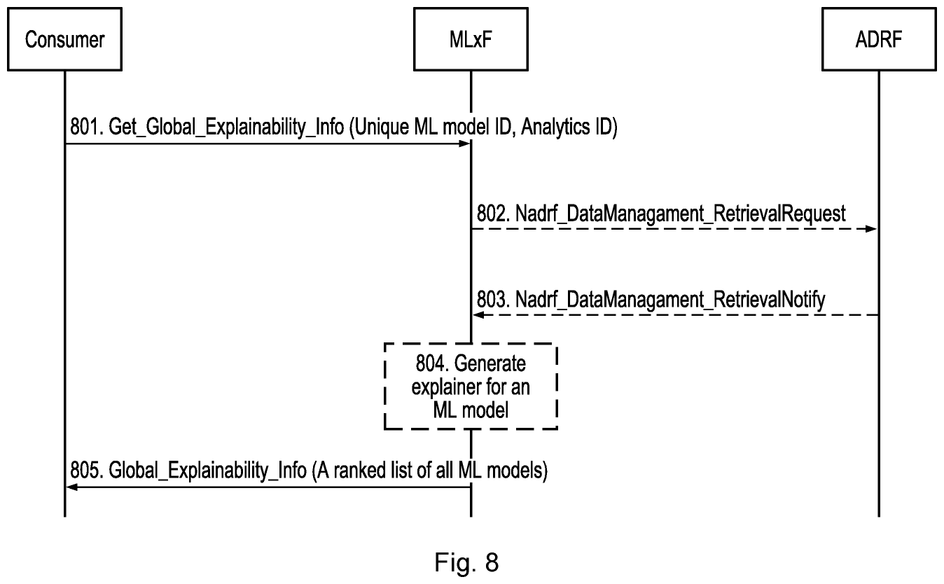

FIG. 8 illustrates an example implementation of steps 701 to 703 of FIG. 7.

In step 801, the MSeF 205 transmits a first request for global weighting values for a first ML model to the MLxF 206. Step 801 comprises an example implementation of step 701.

In this example, the global explainer for the first ML model has not been previously generated and stored by the MLxF 206.

In steps 802 and 803, therefore, the MLxF 206 retrieves samples of training data for the first ML model from a storage function (e.g. ARDF).

In step 804, the MLxF 206 generates a global explainer for the first ML model and utilizes the global explainer to obtain the global weighting values. Step 804 comprises an example implementation of step 702.

A global Explainer is an analytical model created using the first ML model and the historical training data (samples) that was used to train the first ML model. The global explainer is generated to provide global explanations using different processes. There are various known methods for generating a global explainer such as, for SHapley example, Additive explanations (SHAP—https://shap.readthedocs.io/en/latest/index.html) or ELI5 (ELI5—https://eli5.readthedocs.io/en/latest/).

As an example, SHAP is a model-agnostic method for post-hoc explanation (local and/or global) of a given machine learning model through relative feature importance.

The main idea behind SHAP is to compute the Shapley values from cooperative game theory. Shapley values are a way to fairly distribute the gains of a coalition game among its members. In the context of explaining machine learning models, features are considered players, and the gain is the difference between the model's prediction for a specific instance and the average prediction over all possible combinations of features. SHAP computes the Shapley values for each feature by considering all possible subsets of features and averaging the contribution of each feature over all possible combinations of features.

SHAP values can be used to compute global explanation (e.g. global weighting values). The global feature importance measures by aggregating the SHAP values across all instances. SHAP can handle tree-based models, linear models, neural networks, and ensemble models.

The SHAP values can also be used to provide local explanation (e.g. local weighting values, the relative feature importance for each prediction by ranking the importance of features for a specific prediction).

In step 805 the MLxF 206 transmits the global weighting values to the MSeF 205. Step 805 comprises an example implementation of step 703.

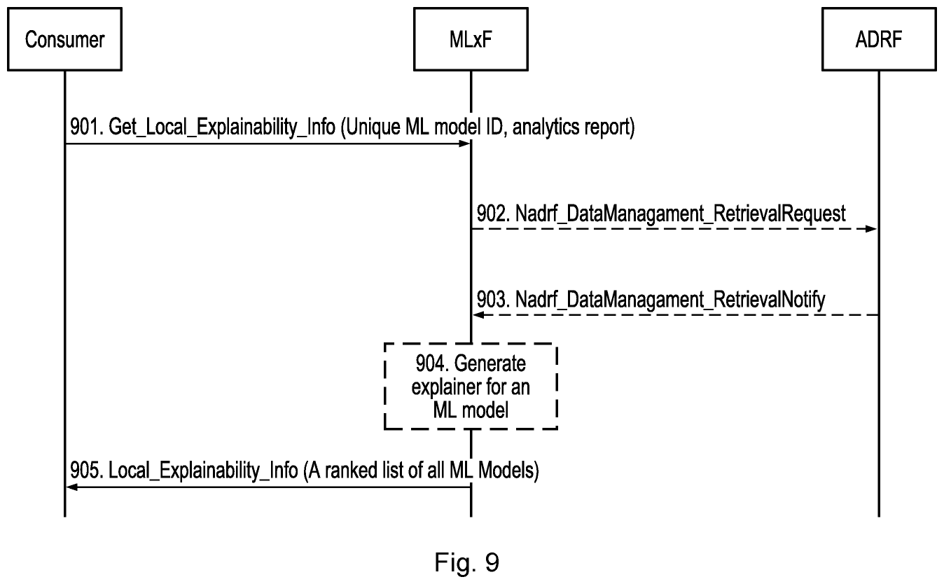

FIG. 9 illustrates an example implementation of steps 704 to 706 of FIG. 7.

In step 901, the MSeF 205 transmits a second request for local weighting values for a first analytics report to the MLxF 206. Step 801 comprises an example implementation of step 701. The second request comprises an indication of the analytics report and the first ML model that generated the analytics report.

In this example, the local explainer for the first analytics report has not been previously generated and stored by the MLxF 206.

In steps 902 and 903, therefore, the MLxF 206 retrieves samples of training data for the first ML model from a storage function (e.g. ARDF).

In step 904, the MLxF 206 generates a local explainer for the first analytics report and utilizes the local explainer to obtain the global weighting values. Step 904 comprises an example implementation of step 705.

A local explainer is an analytical model created using the first ML model and the historical training data (samples) that was used to train the first ML model. The local explainer is generated to provide local explanations using different processes. There are various known methods for generating a local explainer such as, for example, SHapley Additive explanations (SHAP, https://shap.readthedocs.io/en/latest/index.html) or ELI5 (ELI5—https://eli5.readthedocs.io/en/latest/), or Local Interpretable Model-Agnostic Explanations (LIME—“Why Should I Trust You?”: Explaining the Predictions of Any Classifier).

As an example, LIME is a model-agnostic method for local explanation of ML models e.g. it explains the predictions of any machine learning model at the level of individual instances. The specific steps of the LIME method are as follows:
1. Select a specific input instance and corresponding output for which an explanation is needed.
2. Create a neighbourhood around the instance by sampling data points from the original data set.
3. Weights are assigned to the data points in the neighbourhood based on their similarity to the instance of interest.
4. Train a simpler, interpretable model on the weighted subset of data points in the neighbourhood.
5. The simpler model is used to generate feature importances using processes such as LASSO (Least Absolute Shrinkage and Selection Operator), permutation feature importance etc.

In step 905 the MLxF 206 transmits the local weighting values to the MSeF 205. Step 905 comprises an example implementation of step 706.

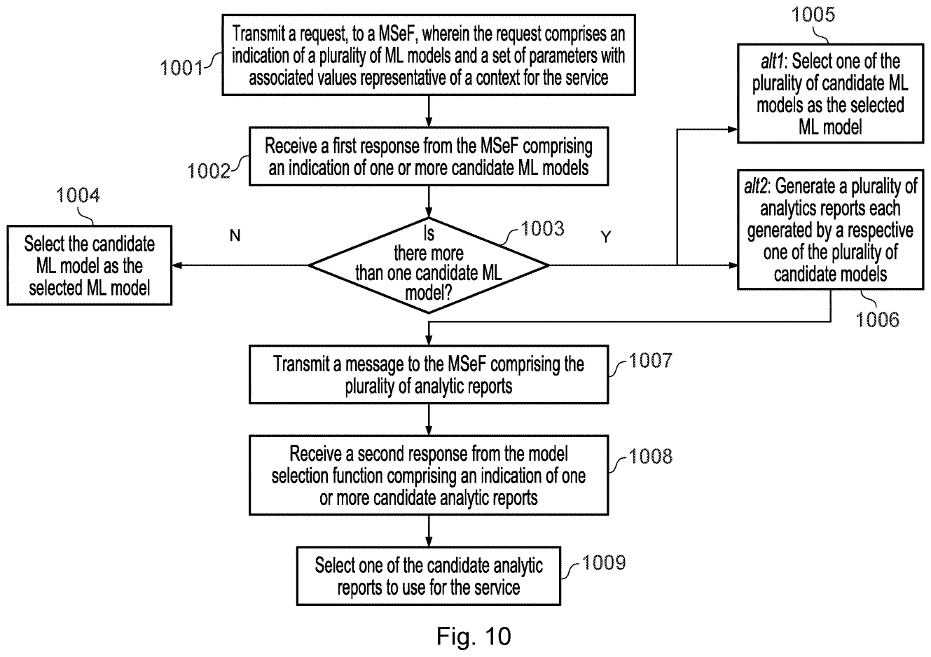

FIG. 10 illustrates a method performed by an analytics function (e.g. AnLF 202), for selecting a selected machine learning, ML, model for use in providing a service at the analytics function. In this embodiment, the AnLF 202 is depicted as forming a separate logical function to the MSeF 205. It will however be appreciated that in some examples at least these two functions (MSeF 205 and AnLF 202) form a single logical function.

In step 1001 the AnLF 202 transmits a request, to a MSeF 205, wherein the request comprises an indication of a plurality of ML models and a set of parameters with associated values representative of a context for the service. Step 1001 comprises an example implementation of step 301.

In step 1002 the AnLF 202 receives a first response from the MSeF 205 comprising an indication of one or more candidate ML models, wherein the first response is indicative of respective model ranks of the one or more candidate ML models. The first response may be defined as described above with reference to FIG. 3.

In some examples, the method of FIG. 10 may further comprise one or more of steps 1003 to 1009.

In step 1003 the AnLF 202 may determine whether there is more than one candidate ML model.

Responsive to there being only one candidate ML model, the method may pass to step 1004 in which the AnLF 202 may select the candidate ML model as the selected ML model to perform the service.

Responsive to there being a plurality of candidate models, the method may either pass to step 1005 in which the AnLF 202 selects the selected ML model from the one or more candidate ML models to perform the service (e.g. by selecting a first listed ML model), or to step 1006 in which the AnLF 202 generates a plurality of analytics reports each generated by a respective one of the plurality of candidate models.

If the method passes to step 1006, the AnLF 202 may then transmit, in step 1007, a message to the MSeF 205 comprising the plurality of analytic reports.

In step 1007 the AnLF 202 receives a second response from the model selection function comprising an indication of one or more candidate analytic reports, wherein the second response is indicative of respective report ranks of the one or more candidate analytic reports. The second response may be defined as described above with reference to FIG. 5.

In step 1009 the AnLF 202 selects one of the one or more candidate analytic reports to use for the service. Responsive to the one or more candidate analytic reports comprising a plurality of candidate analytic reports, step 1009 may comprise selecting one of the candidate analytic reports to use for the service (e.g. first listed analytic report). Responsive to the one or more candidate analytic reports comprising only one candidate analytic report, step 1009 may comprise selecting the candidate analytic report to use for the service.

FIG. 11 illustrates an example implementation of steps 302, 303 and 304 of FIG. 3.

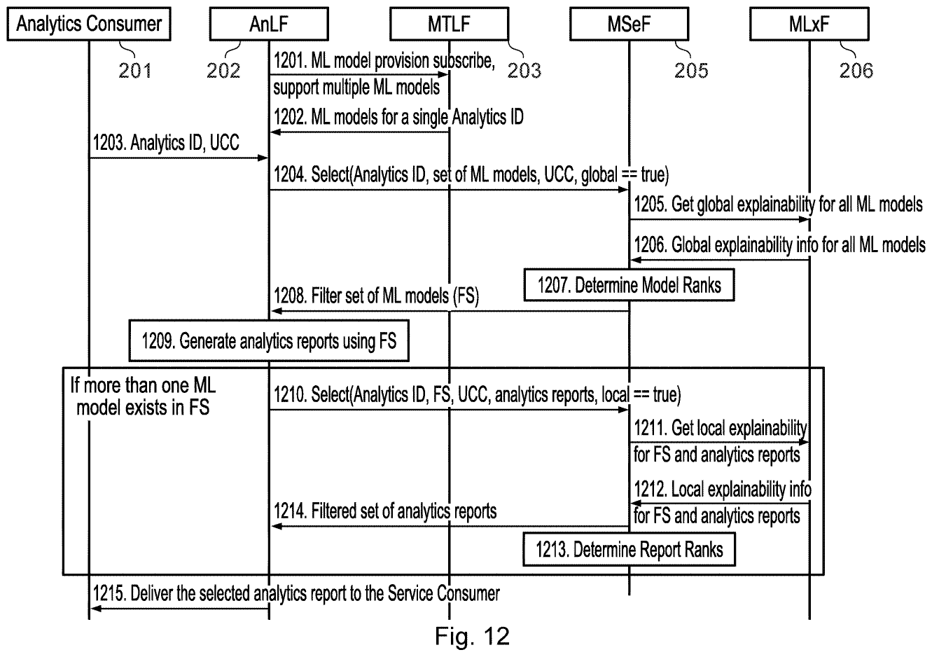

The method of FIG. 11 may be performed by the MSeF 205. As an input to the method of FIG. 11, the MseF 205 may receive an indication of an analytics ID, a plurality of ML models, and a set of UCC parameters (e.g. as will be described in more detail with reference to step 1204 of FIG. 12 below).

In step 1101 the method comprises filtering a stored set of selection rules (e.g. that were provided by a developer and may be applicable to a number of different analytics IDs) based on the analytics ID to obtain a set R of selection rules applicable to the analytics ID.

In step 1102, the method comprises evaluating the logical expressions in the selection rules in the set R based on the UCC parameters. Those selections rules for which the logical expressions evaluate to true are added to the set RT of applicable selection rules in step 1103. Steps 1101 to 1103 comprise an example implementation of step 302 of FIG. 3.

In step 1104 the method comprises initialising aggregate weights aggWᵢ=0 for i=1 . . . n and setting N=|RT|, in other words N is equal to the number of applicable selection rules.

In step 1105 the method comprises determining whether the set RT is empty. If the set RT is not empty the method passes to step 1106 in which a selection rule r is selected from the set RT. AS described above, the selection rule r may have the structure:
R=[analytics ID][logical expression]→[feature₁: w₁, . . . featureᵢ: wᵢ . . . featureₙ: wₙ]

In step 1107 the aggregate weights aggWᵢ are updated as follows:
aggWᵢ=aggWᵢ+wᵢ, i=1 . . . n

In step 1108 the rule r is removed from the set RT. The method then passes back to step 1105.

Once the set RT is empty the method passes to step 1109 in which average weighting values Xᵢ are calculated as Xᵢ=aggWᵢ/N. It will be appreciated that the average weighting values Xᵢ are derived from the selection weighting values wᵢ for each applicable selection rule in the set RT

In step 1110 a model set SM is initialised to comprise the plurality of ML models. A ranking, rank (Mᵢ), for each of the ML models, Mᵢ, is initalised at 0.

In step 1111 the method comprises determining whether the set SM is empty. If the set SM is not empty the method passes to step 1112 in which a ML model Mᵢ is selected from the set SM.

In step 1113 global explainability information is obtained for the ML model, Mᵢ. Step 1113 comprises an example implementation of step 303 of FIG. 3. As previously described the global explainability information for a model Mᵢ may be expressed as:
Global Explainability of Mⱼ→[feature₁: u₁, . . . , fₙ: uₙ].

In step 1114 the rank for the model Mⱼ, rank (Mⱼ), may then be determined as

$$rank ( {M}_{j} ) = {\sum }_{i = 1}^{n} {u}_{i} {X}_{i} .$$

Step 1114 comprises an example implementation of step 304 of FIG. 3.

In step 1115 the model Mᵢ is removed from the set SM and the method passes back to step 1111.

Once the set SM is empty the method passes to step 1116 in which the ranks for the ML models in the set SM are output. It will be appreciated that the MSeF may then utilise these ranks to initiate use of the selected ML model from one or more candidate ML models as described with reference to Step 305 of FIG. 3.

FIG. 12 is a signalling diagram illustrating an example implementation of the methods of FIGS. 3, 5, 7 and 10. In this Figure the functions AnLF 202, MTLF 203, MSeF 205 and MLxF 206 are described as separate logical functions. It will however be appreciated that one or more of these functions may be implemented in a single logical function (e.g. an NWDAF).

In step 1201 an AnLF 202 subscribes to the MTLF 203 to receive notification when ML models for an analytics ID are ready to be used for inference. The AnLF 202 indicates its support for multiple ML models for a single analytics ID in the subscription request for ML model provisioning.

In step 1202, the MTLF 203 notifies the AnLF 202 when the ML models are trained and ready for inference.

In step 1203, an Analytics Service Consumer transmits a request for an analytics report to the AnLF 202 and provides a set of parameters with associated values representative of a context for the service (e.g. UCC parameters). The request also indicates the analytics ID.

In step 1204, the AnLF 202 transmits a request, to a MSeF 205, wherein the request comprises an indication of a plurality of ML models (each one identified by the Unique ML Model Identifier) and a set of parameters (UCC) with associated values representative of a context for the service. The request of step 1204 may further provide an analytics ID of interest, and an indication that global explainability is requested. Step 1204 comprises an example implementation of step 301 and step 1001.

In step 1205, the MSeF 205 transmits request for global weighting values for all of the plurality of ML models to the MLxF 206. Step 1205 comprises an example implementation of steps 701.

The MLxF 206 transmits the back the results of global explainability to MSeF 205. The global explainability information comprises the global weighting values for all of the plurality of ML models. Step 1206 comprises an example implementation of steps 303 and 703.

In step 1207 the MSeF 205 determines model ranks for each of the plurality of ML models using a ranking process, e.g. as described with reference to step 304 of FIG. 3. If any ML model is not given a rank, it is given a default value of zero. This determination may be based on applicable selection rules as described with reference to FIG. 3.

In step 1208, the MSeF 205 filters out the ML models that are not of interest to the AnLF 202 and sends, in this a first response, a list of comprising the Unique ML Model Identifiers of the one or more candidate ML models with the top X model ranks. Step 1208 comprises an example implementation of steps 305 and 1002.

In this example more than one candidate ML model is indicated in the first response.

In step 1209 therefore, the AnLF 202 generates analytics reports from all of the candidate models. Step 1209 comprises an example implementation of step 1006.

In step 1210 the AnLF 202 sends the plurality of analytics reports to the MSeF 205 with indication that “local explainability” is requested. Step 1210 comprises an example implementation of steps 1007 and 501. Step 1210 may further comprise transmitting an indication of the candidate ML models and which of the analytic reports were generated by which candidate ML model. The UCC parameters may also be transmitted in step 1210.

In step 1211, the MSeF 205 transmits a second request for local weighting values for the plurality of analytics reports to the MLxF 206. Step 1211 comprises an example implementation of step 704.

In step 1212, the MLxF 206 transmits the local weighting values for the plurality of analytics reports to the MSeF 205. Step 1212 comprises an example implementation of steps 706 and 502.

In step 1213, the MSeF 205 determines report ranks for the plurality of analytics reports using a ranking process (e.g. as described with reference to step 503 of FIG. 5). If any analytics report is not given a rank, it may be given a default value of zero.

In step 1214 the candidate analytics reports with the top Z report ranks are transmitted to the AnLF 202. Step 1214 comprises an example implementation of steps 504 and 1008.

If there is a single candidate analytic report, the AnLF 202 responds, in step 1215 to the Service Consumer with the analytics report. Otherwise, the AnLF 202 may utilise some internal logic (e.g. to select first indicate analytic report in step 1214 to select one of the candidate analytic report and transmits the selected analytic report to the service consumer.

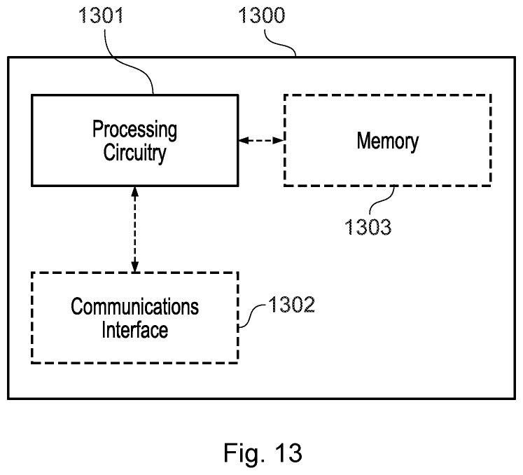

FIG. 13 illustrates a network function 1300 (e.g. a MSeF, and MLxF or an AnLF) comprising processing circuitry (or logic) 1301. The processing circuitry 1301 controls the operation of the network function 1300 and can implement the method described herein in relation to an network function 1300. The processing circuitry 1301 can comprise one or more processors, processing units, multi-core processors or modules that are configured or programmed to control the network function 1300 in the manner described herein. In particular implementations, the processing circuitry 1301 can comprise a plurality of software and/or hardware modules that are each configured to perform, or are for performing, individual or multiple steps of the method described herein in relation to the network function 1300. It will be appreciated that the network function 1300 may comprise one or more virtual machines running different software and/or processes. The network function 1300 may therefore comprise, or be implemented in or as one or more servers, switches and/or storage devices and/or may comprise cloud computing infrastructure that runs the software and/or processes.

Briefly, the processing circuitry 1301 of the network function 1300 is configured to perform the method as described herein with reference to a MSeF and MLxF or an AnLF or a combination thereof.

In some embodiments, the network function 1300 may optionally comprise a communications interface 1302. The communications interface 1302 of the network function 1300 can be for use in communicating with other nodes, such as other virtual nodes. For example, the communications interface 1302 of the network function 1300 can be configured to transmit to and/or receive from other nodes requests, resources, information, data, signals, or similar. The processing circuitry 1301 of network function 1300 may be configured to control the communications interface 1302 of the network function 1300 to transmit to and/or receive from other nodes requests, resources, information, data, signals, or similar. The communications interface 1302 can use any suitable communication technology.

Optionally, the network function 1300 may comprise a memory 1303. In some embodiments, the memory 1303 of the network function 1300 can be configured to store program code that can be executed by the processing circuitry 1301 of the network function 1300 to perform the method described herein in relation to the network function 1300. Alternatively or in addition, the memory 1303 of the network function 1300, can be configured to store any requests, resources, information, data, signals, or similar that are described herein. The processing circuitry 1301 of the network function 1300 may be configured to control the memory 1303 of the network function 1300 to store any requests, resources, information, data, signals, or similar that are described herein. The network function 1300 may be configured operate in the manner described herein in respect of an network function.

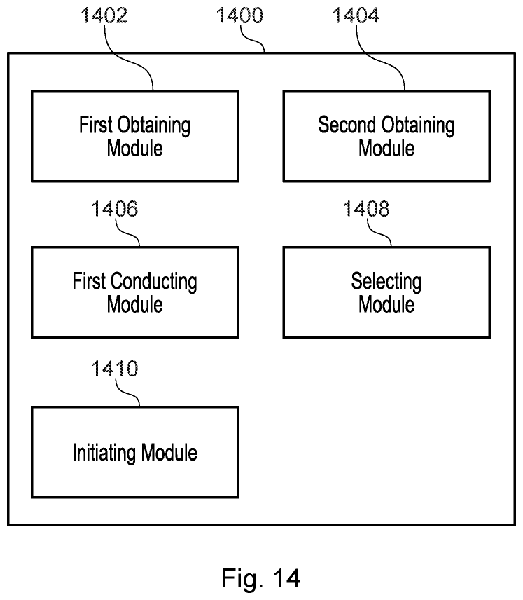

FIG. 14 is a block diagram illustrating a model selection function 1400 according to some embodiments. The model selection function 1400 can enable selection of a selection ML model for use in providing a service. The model selection function 1400 comprises a first obtaining module 1402 configured to obtain an indication of a plurality of ML models and a set of parameters with associated values representative of a context for the service. The model selection function 1400 comprises a first determining module 1404 configured to determine, based on the set of parameters with associated values, at least one applicable selection rule, wherein each applicable selection rule is associated with a logical expression which, when evaluated over one or more of the set of parameters, is true, and wherein each applicable selection rule comprises selection weighting values, wᵢ, indicating weightings to be applied to respective features, featureᵢ, in determining respective ranks of the plurality of ML Models, wherein each respective feature comprises a input feature for at least one of the plurality of ML models. The model selection function 1400 comprises a second obtaining module 1406 configured to, for each first ML model in the plurality of ML models, obtain global weighting values, uᵢ, indicating relative impacts of the respective features when the first ML model outputs predictions. The model selection function 1400 comprises a second determining module 1408 configured to, for each first ML model in the plurality of ML models, determine a model rank of the first ML model from the global weighting values and the selection weighting values. The model selection function 1400 comprises an initiating module 1410 configured to initiate use of the selected ML model from one or more candidate ML models based on the respective model ranks of the one or more candidate ML models.

The model selection function 1400 may operate in the manner described herein in respect of an model selection function.

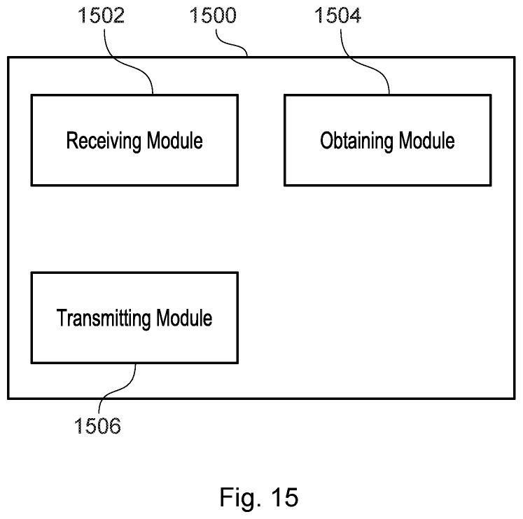

FIG. 15 is a block diagram illustrating a model explanation function 1500 according to some embodiments. The model explanation function 1500 comprises a receiving module 1502 configured to receive a first request, from a first function, for global weighting values for a first ML model, wherein the global weighting values indicate relative impacts of respective features when the first ML model outputs predictions. The model explanation function 1500 comprises an obtaining module 1504 configured to obtain the global weighting values for the first ML model. The model explanation function 1500 comprises a transmitting module 1506 configured to transmit the global weighting values to the first function. The model explanation function 1500 may operate in the manner described herein in respect of a model explanation function.

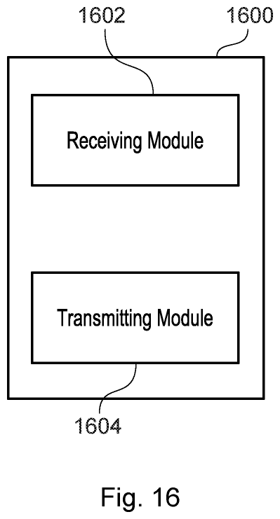

FIG. 16 is a block diagram illustrating an analytics function 1600 according to some embodiments. The analytics function 1600 comprises a transmitting module 1602 configured to transmit a request, to a model selection function, wherein the request comprises an indication of a plurality of ML models and a set of parameters with associated values representative of a context for the service. The analytics function 1600 comprises a receiving module 1604 configured to receive a first response from the model selection function comprising an indication of one or more candidate ML models, wherein the first response is indicative of respective model ranks of the one or more candidate ML models. The analytics function 1600 may operate in the manner described herein in respect of an analytics function.

There is also provided a computer program comprising instructions which, when executed by processing circuitry (such as the processing circuitry 1301 of the network function 1300 described earlier), cause the processing circuitry to perform at least part of the method described herein. There is provided a computer program product, embodied on a non-transitory machine-readable medium, comprising instructions which are executable by processing circuitry to cause the processing circuitry to perform at least part of the method described herein. There is provided a computer program product comprising a carrier containing instructions for causing processing circuitry to perform at least part of the method described herein. In some embodiments, the carrier can be any one of an electronic signal, an optical signal, an electromagnetic signal, an electrical signal, a radio signal, a microwave signal, or a computer-readable storage medium.

In embodiments described herein, by employing global explainability, a MSeF is able to select the most appropriate ML model based on the UCC and set of applicable selection rules, e.g. submitted by the service consumer or developer. Moreover, local explainability may be used to choose the most accurate analytics report, among all generated analytics reports by the ML models from global explainability step.

Using explainability methods as explained herein, an NWDAF may be able to provide the most relevant and accurate analytics report, in response to a request from an NF in the network. This will lead to more accurate predictions, which in turn will assist NFs to trigger correct actions efficiently and accordingly, avoiding degradation in network performance.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A method, performed by a model selection function for enabling selection of a selected machine learning (ML) model for use in providing a service, the method comprising:
obtaining an indication of a plurality of ML models and a set of parameters with associated values representative of a context for the service;
determining, based on the set of parameters with associated values, at least one applicable selection rule, wherein each applicable selection rule is associated with a logical expression which, when evaluated over one or more of the set of parameters, is true, and wherein each applicable selection rule comprises selection weighting values, wᵢ, indicating weightings to be applied to respective features, featureᵢ, in determining respective ranks of the plurality of ML models, wherein each respective feature comprises a input feature for at least one of the plurality of ML models;
for each first ML model in the plurality of ML models:
obtaining global weighting values, uᵢ, indicating relative impacts of the respective features when the first ML model outputs predictions; and
determining a model rank of the first ML model from the global weighting values and the selection weighting values; and
initiating use of the selected ML model from one or more candidate ML models based on the respective model ranks of the one or more candidate ML models.

2. The method as claimed in claim 1, wherein step of obtaining an indication of the plurality of ML models comprises:
receiving the indication of the plurality of ML models and the set of parameters with associated values representative of a context for the service from a consumer.

3. The method as claimed in claim 2, wherein the step of initiating comprises transmitting a first response to the consumer comprising an indication of the one or more candidate ML models, wherein the first response is indicative of the respective model ranks of the one or more candidate ML models.

4. The method as claimed in claim 3, wherein the one or more candidate ML models have respective model ranks that meet a criterion.

5. The method as claimed in claim 4, wherein the one or more candidate ML models comprises Y ML models, where Y is an integer number, associated with a Y highest respective model ranks.

6. The method as claimed in claim 4, wherein the one or more candidate ML models are associated with respective model ranks that are greater than a predetermined threshold.

7. The method as claimed in claim 3, wherein the first response comprises an indication of the respective model ranks for the one or more candidate ML models.

8. The method as claimed in claim 3, wherein obtaining the global weighting values comprises:
transmitting a request for the global weighting values to a model explainer function, wherein the request comprises an indication of the first ML model; and
responsive to transmitting the request, receiving the global weighting values from the model explainer function.

9. The method as claimed in claim 1, wherein determining a respective model rank of the first ML model from the global weighting values and the selection weighting values comprises:
for each feature, featureᵢ, multiplying the respective global weighting value, uᵢ and the respective selection weighting value, wᵢ to determine a model feature weighting, uᵢwᵢ, and
summing of the model feature weightings for all features.

10. The method as claimed in claim 1, further comprising:
responsive to the one or more candidate ML models comprising a plurality of candidate ML models, obtaining a plurality of analytic reports each generated by a respective one of the plurality of candidate ML models.

11. The method as claimed in claim 10, further comprising:
for each first analytic report in the plurality of analytic reports:
obtaining local weighting values, uᵢ, indicating relative impacts of respective features in the first analytic report; and
determining a report rank of the first analytic report from the local weighting values and the selection weighting values; and
initiating use of the selected ML model from the plurality of candidate ML models based on the respective report ranks of the plurality of analytic reports.

12. The method as claimed in claim 11, wherein the step of initiating comprises transmitting a second response to the consumer comprising an indication of one or more candidate analytic reports, wherein the second response is indicative of the respective report ranks of the one or more candidate analytic reports.

13. The method as claimed in claim 12, wherein the one or more candidate analytic reports have respective report ranks that meet a criterion.

14. The method as claimed in claim 13, wherein the one or more candidate analytic reports comprises X analytic reports, where X is an integer number, associated with a X highest respective report ranks.

15. (canceled)

16. The method as claimed in claim 12, wherein the second response comprises an indication of the respective report ranks for the one or more candidate analytic reports.

17. The method as claimed in claim 12, wherein obtaining the local weighting values comprises:
transmitting a request for the local weighting values to a model explainer function, wherein the request comprises the first analytic report; and
responsive to transmitting the request, receiving the global weighting values from the model explainer function.

18. The method as claimed in claim 11, wherein determining a respective report rank of the first analytic report from the local weighting values and the selection weighting values comprises:
for each feature, featureᵢ, multiplying the respective local weighting value, vᵢ and the respective selection weighting value, wᵢ to determine a report feature weighting, vᵢwᵢ, and
summing of the report feature weightings for all features.

19. A method, performed by a model explanation function, for enabling selection of a selected machine learning (ML) model for use in providing a service, the method comprising:
receiving a first request, from a first function, for global weighting values for a first ML model, wherein the global weighting values indicate relative impacts of respective features when the first ML model outputs predictions;
obtaining the global weighting values for the first ML model; and
transmitting the global weighting values to the first function.

20.-24. (canceled)

25. A method, performed by an analytics function, for selecting a selected machine learning (ML) model for use in providing a service at the analytics function, the method comprising:
transmitting a request, to a model selection function, wherein the request comprises an indication of a plurality of ML models and a set of parameters with associated values representative of a context for the service; and
receiving a first response from the model selection function comprising an indication of one or more candidate ML models, wherein the first response is indicative of respective model ranks of the one or more candidate ML models.

26.-45. (canceled)

46. A computer program product comprising a non transitory computer readable media having stored thereon a computer program comprising instructions which, when executed on processing circuitry, cause the processing circuitry to carry out the method according to claim 1.
